(19) United States
(12) Patent Application Publication
(10) Pub. No.: US 2008/0265784 A1
(43) Pub. Date: Oct. 30, 2008

(54) Gas excitation light-emitting device

(76) Inventors: Hyoung-Bin Park, Suwon-si (KR); Seung-Hyun Son, Suwon-si (KR); Mun-Ho Nam, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/149,028

(22) Filed: Apr. 25, 2008

(30) Foreign Application Priority Data
Apr. 27, 2007 (KR) 10-2007-0041617

(51) Int. Cl. G09G 3/10; H01J 1/62

(52) U.S. Cl. 315/169.1; 313/485

(57) ABSTRACT

A gas excitation light-emitting device, including a first substrate and a second substrate with a plurality of cells are defined between the first substrate and the second substrate, an excitation gas in each of the cells, a phosphor layer in each of the cells, a plurality of electrodes disposed between the first substrate and the second substrate, an electron accelerating layer emitting an E-beam in each of the cells, wherein, for each of the cells, the electron accelerating layer excites the excitation gas in the cell when a voltage is applied to corresponding ones of the electrodes of the cell, and the respective phosphor layer is spaced apart from the electrodes of the cell and the phosphor layer is arranged in a portion of the cell other than a portion of the cell between corresponding ones of the electrodes of the cell.

### BACKGROUND OF THE INVENTION

1. Field of the Invention

Embodiments relate to a gas excitation light-emitting device. More particularly, embodiments relate to a gas excitation light-emitting device having reduced driving voltage and improved luminous efficiency.

2. Description of the Related Art

Plasma discharge phenomenon is employed to produce light in a variety of devices, e.g., plasma display panels (PDPs) and flat lamps.

Flat lamps may employ plasma discharge phenomenon to generate light. For example, flat lamps may be employed as a backlight for a liquid crystal display (LCD).

PDPs form images using electrical discharge, have good brightness characteristics and a wide viewing angle. PDPs display images using visible light emitted through a process of exciting a phosphor material with ultraviolet rays generated from a discharge of a discharge gas between electrodes when a direct current (DC) voltage or an alternating current (AC) voltage is applied to the electrodes.

In general, PDPs are classified as facing discharge type panels and surface discharge type panels according to the arrangement of the electrodes. In facing discharge type panels, two sustaining electrodes constituting a pair are respectively disposed on an upper substrate and a lower substrate, and thus, discharge occurs in a direction perpendicular to each of the upper substrate and the lower substrate. In the surface discharge type panels, two sustaining electrodes constituting a pair are formed on the same substrate, and thus, discharge occurs in a direction parallel to the substrate.

More particularly, in such devices, ultraviolet light may be generated when excited ionized gas atoms, e.g., Xe atoms, stabilize, i.e., electron(s) return to their original energy level. That is, such devices generally require a relatively large amount of energy to ionize the discharge gas to generate ultraviolet light. Thus, such devices generally require a relatively high driving voltage, and a luminous efficiency thereof is relatively low.

### SUMMARY OF THE INVENTION

Embodiments of the invention are therefore directed to a gas excitation light-emitting device, which substantially overcomes one or more of the problems due to the limitations and disadvantages of the related art.

It is therefore a feature of an embodiment of the invention to provide a gas excitation light-emitting device with reduced power consumption.

It is therefore a separate feature of an embodiment of the invention to provide a gas excitation light-emitting device with improved luminous efficiency.

It is therefore a separate feature of an embodiment of the invention to provide a gas excitation light-emitting device in which an image may be formed using only an energy of electrons emitted when an electron accelerating layer is excited.

It is therefore a separate feature of an embodiment of the invention to provide a gas excitation light-emitting device that may be operated with a reduced driving voltage

It is therefore a separate feature of an embodiment of the invention to provide a gas excitation light-emitting device in which an exposed area of an electrode in a cell of the device may be reduced.

It is therefore a separate feature of an embodiment of the invention to provide a gas excitation light-emitting device in which an area of a phosphor layer coated in a cell of the device may be increased.

It is therefore a separate feature of an embodiment of the invention to provide a gas excitation light-emitting device in which a brightness of a phosphor layer of the device may be improved.

Embodiments of the invention may separately provide such gas excitation light-emitting devices including any one or more of the above and/or other features and/or advantages of the invention in a reflective-type or backlit-types gas excitation light-emitting device, e.g., a flat lamp, PDP, etc.

At least one of the above of and other features of the invention may be realized by providing a gas excitation light-emitting device, including a first substrate and a second substrate that are disposed facing each other by a predetermined interval, wherein a plurality of cells are defined between the first substrate and the second substrate, an excitation gas in each of the cells, a phosphor layer in each of the cells, a plurality of electrodes disposed between the first substrate and the second substrate, and an electron accelerating layer emitting an E-beam in each of the cells, wherein, for each of the cells, the electron accelerating layer excites the excitation gas in the cell when a voltage is applied to corresponding ones of the electrodes of the cell, the phosphor layer is spaced apart from the electrodes of the cell, and the phosphor layer is arranged in a first portion of the cell other than a second portion of the cell between corresponding ones of the electrodes of the cell.

The phosphor layer may be formed on an entire cell-facing surface portion of at least one of the first substrate and the second substrate of the respective cell.

The electron accelerating layer may include oxidized porous silicon.

The device may include a first barrier rib partially extending between adjacent ones of the cells and protruding from the second substrate, wherein a portion of the respective phosphor layer also covers a portion of the barrier rib.

A portion of the phosphor layer on the barrier rib may be thicker than a portion of the phosphor layer on the second substrate.

For each of the cells, the electrodes may include a first electrode and a second electrode, wherein the first electrode may be arranged on the first substrate with the electron accelerating layer stacked thereon, and the second electrode may be arranged between adjacent ones of the cells and stacked with the first barrier rib between the first substrate and the second substrate.

The second electrode may protrude into the cell relative to the first barrier rib.

The device may further include a first dielectric material layer between the first substrate and the second electrode.

The device may further include a third electrode between the first barrier rib and the first substrate.

The device may further include a second dielectric material layer between the second electrode and the third electrode.

The device may further include a reflective layer formed between the second substrate and the phosphor layer.

At least one of the electrodes may be arranged between adjacent ones of the cells, and the device further may further include a second barrier rib between respective portions of the at least one of the electrodes between adjacent ones of the cells.

At least one dielectric material layer may also be arranged between adjacent ones of the cells and between the at least one electrode and the first substrate, and the second barrier rib may extend between respective portions of the at least one dielectric material layer.

The device may further include a first barrier rib arranged on the at least one electrode, wherein the first barrier rib, the at least one second electrode and the at least one dielectric material layer are stacked on each other between the first and second substrates, and the second barrier rib protrudes from the first substrate and extends between the respective portions of the at least one electrode and the respective portions of the at least one dielectric material layer.

For each of the cells, the respective phosphor layer may be arranged on one of an upper portion and a lower portion of the cell, and respective corresponding portions of the electrodes may be arranged on the other of the upper portion and the lower portion of the cell.

The first portion may be one of an upper portion and a lower portion of the cell, and the second portion may be the other of the upper portion and the lower portion of the cell.

At least one of the above of and other features of the invention may be realized by providing a gas excitation light-emitting device, including a first substrate and a second substrate that are disposed facing each other by a predetermined interval, wherein a plurality of cells are defined between the first substrate and the second substrate, an excitation gas fills the cells, a phosphor layer disposed in each of the cells, a plurality of electrodes disposed between the first substrate and the second substrate, and an electron accelerating layer emitting an E-beam that excites the excitation gas in the cells, wherein the electrodes are disposed on one of the first substrate and the second substrate, the phosphor layer is disposed on the other one of the first substrate and the second substrate, and the phosphor layer is spaced apart from the electrodes.

A gas excitation light-emitting device including a first substrate and a second substrate which are disposed facing each other by a predetermined interval, wherein a plurality of cells are formed between the first substrate and the second substrate, an excitation gas filled into the cells, a phosphor layer formed on an inner wall of the cells, a first electrode and a second electrode formed on the substrate as a pair that define a discharge space that is defined between the first substrate and the second substrate, so as to form the cells, a third electrode formed inside the first electrode; and a first electron accelerating layer formed between the first substrate and the third substrate, and which emits a first E-beam that excites the excitation gas in the cells when a voltage is applied to the first electrode and the third electrode.

The phosphor layer may be formed on the entire surface of one of the first substrate and the second substrate.

The device may further include a fourth electrode formed inside the second electrode, and a second electron accelerating layer formed between the second electrode and the fourth electrode, and which emits a second E-beam that excites the excitation gas in the cell when a voltage is applied to the second electrode and the fourth electrode.

The first electron accelerating layer and the second electron accelerating layer may include oxidized porous silicon.

Each of the third electrode and the fourth electrode may have a mesh structure.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic of a cross-sectional view of a gas excitation light-emitting device according to an exemplary embodiment of the invention;

FIG. 2 illustrates a graph illustrating energy levels of Xe;

FIG. 3 illustrates a cross-sectional view of a gas excitation light-emitting device according to another exemplary embodiment of the invention;

FIG. 4 illustrates a cross-sectional view of a gas excitation light-emitting device according to another embodiment of the invention;

FIG. 5 illustrates a cross-sectional view of a gas excitation light-emitting device according to another exemplary embodiment of the invention;

FIG. 6 illustrates a cross-sectional view of a gas excitation light-emitting device according to another exemplary embodiment of the invention; and

FIG. 7 illustrates a cross-sectional view of a gas excitation light-emitting device according to another exemplary embodiment of the invention.

### DETAILED DESCRIPTION OF THE INVENTION

Korean Patent Application No. 10-2007-0041617, filed on Apr. 27, 2007, in the Korean Intellectual Property Office, and entitled: “Gas Excitation Light-Emitting Device,” is incorporated by reference herein in its entirety.

Exemplary embodiments will be described more fully hereinafter with reference to the accompanying drawings, in which exemplary embodiments of the invention are illustrated. Embodiments may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. As used herein, the singular forms “a,” “an” and “the” are intended to include the plural forms as well, unless the context clearly indicates otherwise. It will also be understood that when an element is referred to as being “on,” “below” or “above” another element, it can be directly “on,” “below” or “above” the other element, or intervening elements may also be present. In addition, it will also be understood that, unless specified otherwise, when an element is referred to as being “between” two elements, it can be the only element between the two elements, or one or more intervening elements may also be present. Like reference numerals refer to like elements throughout the specification.

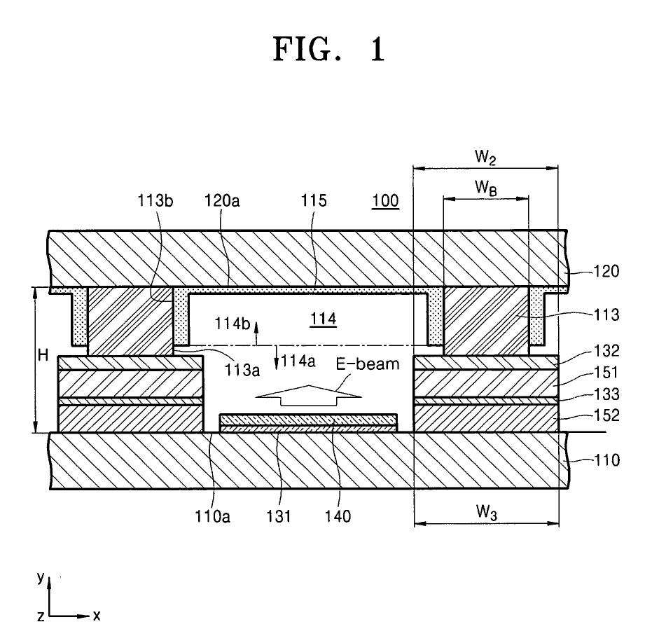

FIG. 1 illustrates a schematic of a cross-sectional view of a gas excitation light-emitting device 100 according to an exemplary embodiment of the invention.

Referring to FIG. 1, the gas excitation light-emitting device 100 may include a first substrate 110, a second substrate 120, a barrier rib 113, a cell 114, a first electrode 131, a second electrode 132, a third electrode 133, an electron accelerating layer 140, a first dielectric material layer 151, and a second dielectric material layer 152. In the exemplary embodiment illustrated in FIG. 1, one single cell 114 is illustrated. However, embodiments are not limited thereto. In embodiments including a plurality of the cells 114, the cells 114 may be arranged in, e.g., a matrix format.

The first substrate 110, e.g., a lower substrate, and the second substrate 120, e.g., an upper substrate, may be disposed facing each other by a predetermined interval. The first substrate 110 may be formed of a transparent glass substrate. The second substrate 120 may be formed of a transparent glass substrate.

The cell(s) 114 may be formed between the first substrate 110 and the second substrate 120. Each cell 114 may correspond to a respective space between the first substrate 110 and the second substrate 120. More particularly, e.g., each respective space may be at least partially defined by a combination of the first substrate 110, the second substrate 120 and corresponding portions of electrode(s), dielectric material layer(s) and/or barrier rib(s).

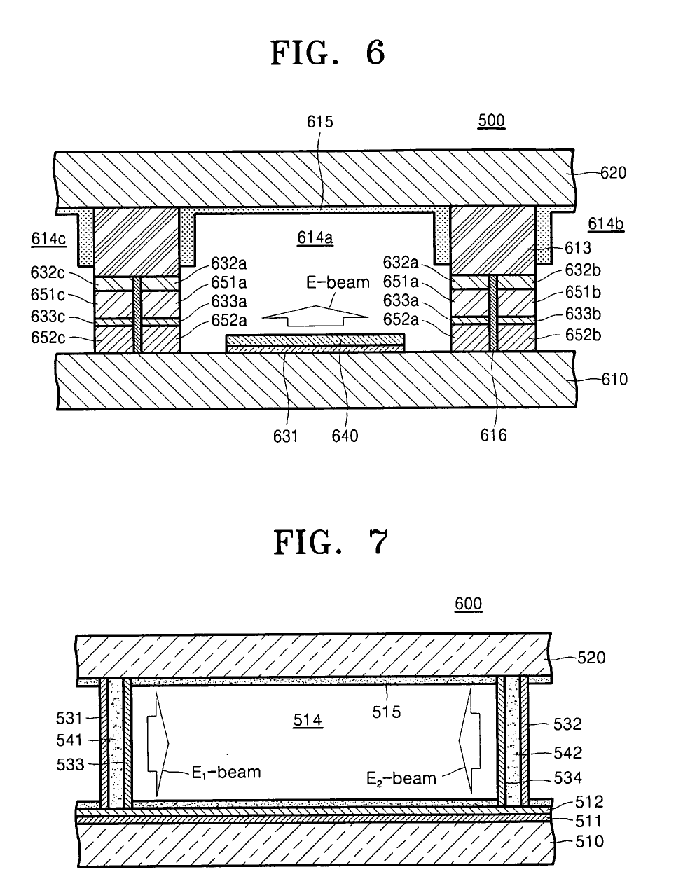

The barrier rib(s) 113 may prevent and/or reduce electrical and optical crosstalk between the cells 114. The barrier rib 113 may be interposed between the second electrode 132 and the second substrate 120 to define respective cells 114. The barrier rib 113 may have a striped structure or a matrix structure. The barrier rib 113 may be formed on the second electrode 132 using, e.g., a printing method or the like. In some embodiments, the barrier rib(s) 113 may be integrally formed on a side of the second substrate 120. The barrier rib(s) 113 may protrude from a side of the second substrate 120 facing the first substrate 110. Respective portions of the barrier rib(s) may correspond to a border(s) between adjacent ones of the cells 114. In some embodiments, the barrier rib(s) 113 may protrude from the second substrate 120 so as to partially and/or completely define cell-facing-surface portion(s) 120a of the second substrate 120, i.e., surface portion(s) of second substrate 120 overlapping the respective cell 114. In some embodiments, a barrier rib may not be formed. In such embodiments, e.g., the second electrode 132 and/or the third electrode 133 may at least partially define the respective cells 114. More particularly, FIG. 6 described below illustrates another exemplary embodiment without barrier rib(s) 113.

In some embodiments, the second electrode 132, the third electrode 133 and/or the barrier rib 113 may be at least partially stacked on each other. More particularly, in some embodiments of the invention, a combination of the barrier rib(s) 113, the electrode(s), e.g., the second and third electrodes 132, 133, and the dielectric material layer(s), e.g., the first and second dielectric material layers 151, 152 may be stacked between the first and second substrates 110, 120. In some embodiments, the stacked combination of the barrier rib, the electrode(s) and the dielectric material layer(s) may have a height H, along a y-direction, equal to the interval between the first substrate 110 and the second substrate 120. For example, in some embodiments, a stacked combination of corresponding ones of the barrier rib(s) 113, the second electrode 132, the third electrode 133, the first dielectric layer 151 and the second dielectric layer 152 may have a height H equal to the interval between the first and second substrates 110, 120.

A phosphor layer 115 corresponding to one of red (R), green (G) and blue (B) light may be coated on inner wall(s)/surface(s) of the respective cell 114, e.g., on the barrier rib(s) 113 and/or the substrates 110, 120. In the exemplary embodiment illustrated in FIG. 1, the phosphor layer 115 is coated on an entire cell-facing-surface portion 120a of the second substrate 120, i.e., entire surface portion of second substrate 120 exposed to the respective cell 114, and a portion 113b, e.g., upper portion, of the barrier rib(s) 113. Further, in some embodiments, e.g., the exemplary embodiment illustrated in FIG. 1, the phosphor layer 115 is coated directly on the entire cell-facing-surface portion 120a of the second substrate 120. However, embodiments of the invention are not limited thereto.

Further, in general, a brightness of a phosphor layer may be improved by increasing an area thereof. Additionally, in general, a quantity of electrons emitted from an electron accelerating layer directly influences a brightness of a cell and an efficiency of the electrons. However, phosphor layers are generally poor conductors, and when the phosphor layer is between electrodes, e.g., the first electrode 131 and the second or third electrodes 132, 133, electrons may accumulate on a surface of the phosphor layer and brightness may be reduced, i.e., efficiency may be reduced. More particularly, when the phosphor layer is arranged along a direct path between corresponding ones of the electrodes, electrons may accumulate on a surface of the phosphor layer and brightness may be reduced. Therefore, in devices in which a phosphor layer is arranged between electrodes, a thickness and/or area of the phosphor is generally reduced.

In embodiments of the invention, a phosphor layer, e.g., the phosphor layer 115, may be arranged so as not to be between and/or in contact with respective electrodes. For example, as discussed above, in the exemplary embodiment shown in FIG. 1, the phosphor layer 115 is arranged so as not to be between and/or in contact with the first electrode 131 and the second and/or third electrodes 132, 133, but rather on the entire cell-facing-surface portion 120a of the second substrate 120 and/or a portion 113b, e.g., upper portion, of the barrier rib(s) 113. That is, e.g., the phosphor layer 115 may be arranged so as not to be along a direct path between corresponding ones of the electrodes, e.g., not along a direct path between and not in contact with the first electrode 131 and the second electrode 132, and not along a direct path between and not in contact with the first electrode 131 and the third electrode 133. Thus, in embodiments, an area and/or a thickness of a phosphor layer may be increased. More particularly, in embodiments, a thickness of a phosphor layer on at least the cell-facing-surface portion 120a of the second substrate 120 may be increased. More particularly, in some embodiments, all the electrodes, e.g., 131, 132, 133, may be arranged in a first portion 114a, e.g., lower portion, of the cell 114 or below the barrier ribs 113, while the phosphor layer 115 may be covered on all or substantially all of a second portion 114b, e.g., upper portion, of the cell 114 that is free of the electrodes, e.g., 131, 132, 133 such as, e.g., an upper portion of the cell 114 including the second substrate 120 and the barrier ribs 113. When the phosphor layer 115 is not in contact with and/or between respective corresponding electrodes of a respective cell 114, electrons may not accumulate on the phosphor layer 114 and thus, drop in electric potential that may prevent or reduce current flow may be substantially and/or completely prevented.

In some embodiments, the exemplary gas excitation light-emitting device 100 of FIG. 1 may correspond to a backlit structure in which an image may be displayed on a side of the second substrate 120. In such embodiments, the phosphor layer 115 may be formed so as to generate visible rays, and simultaneously transmit the generated visible rays. In some embodiments, e.g., the phosphor layer 115 may have a thickness equal to or within a range of about 5 μm to about 20 μm relative to a surface on which the phosphor layer 115 is formed. Further, as shown in FIG. 1, in some embodiments, a thickness of a portion of the phosphor layer 115 on the second substrate 120 may be less than a thickness of a portion of the phosphor layer 115 on the barrier rib(s) 113. Embodiments are not, however, limited thereto.

At least relative to cases in which an electrode, e.g., a second electrode, is formed on a second substrate, in some embodiments of the invention, e.g., the exemplary gas excitation light-emitting device 100 of FIG. 1, a surface area of the phosphor layer 115 on the second substrate 120 may be increased. That is, in some embodiments of the invention, the phosphor layer 115 may be formed on an entire or substantially entire cell-facing-surface portion 120a of the second substrate 120 corresponding to the respective cell(s) 114. More particularly, in some embodiments of the invention, the phosphor layer 115 may be formed directly on the second substrate 120 corresponding to the respective cell(s) 114. While the exemplary embodiment illustrated in FIG. 1 illustrates the phosphor layer 115 on the cell-facing-surface portion 120a and the barrier rib(s) 113, embodiments of the invention are not limited thereto.

The cell(s) 114 may be filled with an excitation gas including, e.g., Xe. The excitation gas may be a gas that is excited by external energy such as an E-beam so as to emit ultraviolet rays. However, the excited gas according to embodiments may function as a discharge gas.

The first electrode(s) 131 may be formed on the first substrate 110, and a respective portion(s) thereof may correspond to the respective cell(s) 114 adjacent thereto. The third electrode 133 and the second electrode 132 may be stacked on a side, e.g., a same side, of the first electrode 131. More particularly, in some embodiments, a respective one the first electrodes 131 and a respective one of the second electrodes 132 extending along one side of a respective one of the respective cell 140 may be associated with that cell 140, while another one of the first electrodes 131 and another one of the second electrodes 132 adjacent to another side of that cell 140 may be associated with another one of the cells 140 of the gas excitation light-emitting device 100. However, in embodiments in which the second electrode 132 and/or the third electrode 133 may have portions exposed to adjacent ones of the cells 114, as illustrated in FIG. 1, a voltage(s) that is applied to the second and third electrodes 132 and/or 133 may commonly affect adjacent cells 114 adjacent to the respective second and third electrodes 132 and 133. However, embodiments are not limited to such as structure. For example, as discussed below, in the exemplary embodiment illustrated in FIG. 6, electrodes on opposing sides of cell 614 may correspond to the cell 614.

Each of the first, second and third electrodes 131, 132, 133 may have, e.g., a striped pattern. In some embodiments, the first, second and third electrodes 131, 132, 133 may extend parallel and/or substantially parallel to each other. The first electrode 131, the second electrode 132 and the third electrode 133 may correspond to a cathode, an anode and a grid electrode, respectively. In some embodiments, all electrodes, e.g., the first electrode 131, the second electrode 132 and/or the third electrode 133 may be formed on a same substrate, e.g., the first substrate 110 and/or a same portion, e.g., 114a, of the cell 114. For example, referring to FIG. 1, in some embodiments, all electrodes corresponding to the cell 114, e.g., the first electrode 131, the second electrode 132 and/or the third electrode 133 may be formed on an inner surface 110a of the first substrate 110 and the second portion 114a of the cell 114. More particularly, e.g., in some embodiments, no electrodes may be formed on the second substrate 120 and/or the second portion 114b of the cell 114.

Referring to FIG. 1, in some embodiments, the second electrode 132 and the third electrode 133 may protrude beyond an inner surface 113a of the barrier rib(s) 113 into the respective cell(s) 114. That is, in some embodiments, while the second electrode 132 and/or the third electrode 133 may be stacked with the barrier rib(s) 113, a width W₂ of the second electrode 132 and/or a width W₁ of the third electrode 133 may be greater than a width W_{B} of the barrier rib(s) 113 along an x-direction. In some embodiments, by adjusting an amount of protrusion of the second electrodes 132 into the respective cells 114, conductivity of the second electrode(s) 132 may be increased, and accordingly, a thickness, along the y-direction, of the second electrode 132 may be reduced. Similarly, by adjusting an amount of protrusion of the third electrode(s) 133 into the respective cells 114, conductivity of the third electrode(s) 133 may be increased, and accordingly, a thickness, along the y-direction, of the third electrode(s) 133 may be reduced. Thus, embodiments may enable manufacturing costs of the gas excitation light-emitting device 100 to be reduced.

Embodiments of the invention may provide a gas excitation light-emitting device in which an area and/or thickness of a phosphor layer may be increased by not arranging the phosphor layer between and/or in contact with corresponding electrodes of a cell that may function together. Accordingly, embodiments may enable a brightness of a phosphor layer in a cell to be improved. Embodiments of the invention may separately provide a gas excitation light-emitting device in which corresponding electrodes of a cell that may function together are arranged in such a manner to reduce a surface area of the cell corresponding to the electrodes, while maintaining and/or improving conductivity characteristics of the electrodes.

Referring still to FIG. 1, the first dielectric material layer 151 may be interposed between the third electrode 133 and the second electrode 132, and may insulate the third electrode 133 and the second electrode 132. The second dielectric material layer 152 may be interposed between the first electrode 131 and the third electrode 133, and may insulate the first electrode 131 and the third electrode 133.

The electron accelerating layer 140 may be formed on the first electrode 131. The electron accelerating layer 140 may include any material that accelerates electrons so as to generate an E-beam. In some embodiments, the electron accelerating layer 140 may include oxidized porous silicon (OPS), e.g., oxidized porous poly silicon, oxidized porous amorphous silicon, etc. In some embodiments, the electron accelerating layer 140 may include a carbon nanotube (CNT) through which visible rays may be transmitted.

In the exemplary embodiment illustrated in FIG. 1, the first electrode 131 and the electron accelerating layer 140 are stacked on each other. However, embodiments of the invention are not limited thereto. For example, in some embodiments, the first electrode 131 may itself include a material that may accelerate electrons so as to emit an E-beam. That is, e.g., in some embodiments, the first electrode 131 may include a material that may also function as the electron accelerating layer 140.

The electron accelerating layer 140 may accelerate electrons incoming from the first electrode 131 so as to emit an E-beam into the cell(s) 114 when at least a predetermined voltage is applied to each of the first electrode 131 and the third electrode 133 corresponding to the respective cell 114. The E-beam emitted into the respective cell(s) 114 may excite an excitation gas that may stabilize and generate ultraviolet rays that excite the phosphor layer 115. The excited phosphor layer 115 may generate visible rays, which may be emitted towards the second substrate 120 in order to form an image.

The E-beam may have an energy that may be sufficient for and/or greater than an energy required for exciting the excitation gas. In some cases, the E-beam may have an energy less than an energy required for ionizing the excitation gas. A voltage may be applied to the first electrode 131 and the third electrode 133 so as to have an optimized electron energy that can excite the E-beam.

The electron accelerating layer 140 may increase electron emission of a cathode such as the first electrode 131 and, accordingly, may reduce a discharge voltage during discharge of the gas excitation light-emitting device 100. The electron accelerating layer 140 may reduce an amount of energy employable for ionization and ion-acceleration and, accordingly, may improve the efficiency of the gas excitation light-emitting device 100. The electron accelerating layer 140 may provide all or substantially all of the electrons required for emitting light. Thus, during operation of some embodiments, electric discharge may not occur, and loss due to ions may be completely and/or substantially completely prevented.

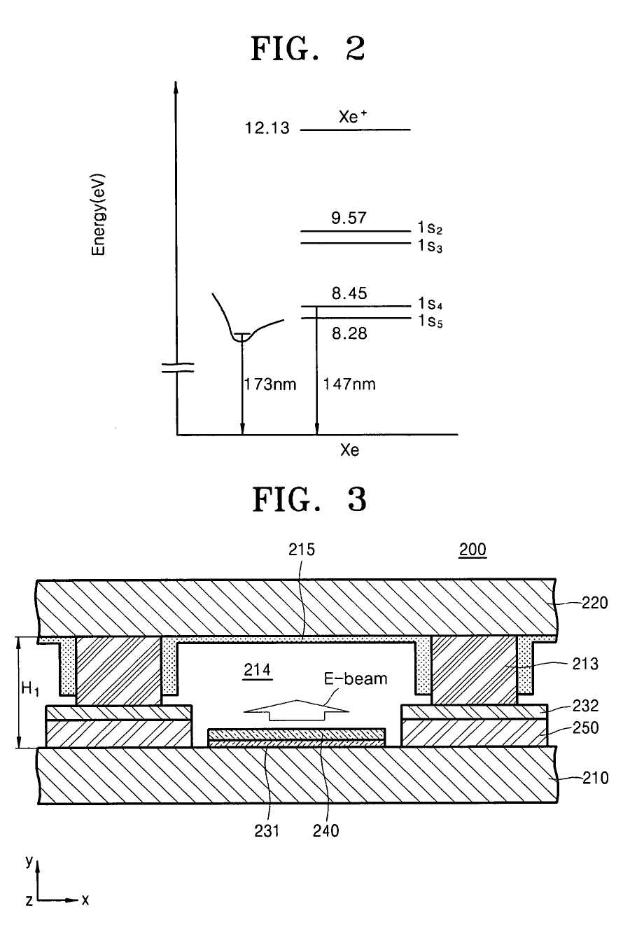

More particularly, e.g., in FIG. 1, if OPS is used as the electron accelerating layer 140, a voltage applied between the first electrode 131, e.g., the cathode, and the third electrode 133, e.g., the grid electrode, may control an output electron energy. Accordingly, in some embodiments, the electron energy may be adjusted to be greater than an excited energy of a gas being employed and less than an ionization energy of the gas being employed. Thus, embodiments of the invention may provide a gas excitation light-emitting device 100, in which only gas excitation occurs, i.e., no gas discharge occurs. Some embodiments of the invention may separately provide a gas excitation light-emitting device 100 in which substantially only gas excitation occurs, without discharge. Additionally, in general, the structure of the exemplary embodiment illustrated in FIG. 1, is not related with the size and efficiency of a discharge cell, may be advantageous in terms of realizing high definition. Additional features of an exemplary gas, e.g., Xe, employable in the gas excitation light-emitting device 100 will be described in more detail with reference to FIG. 2.

FIG. 2 illustrates a graph illustrating energy levels of Xe. Referring to FIG. 2, it can be seen that an energy of 12.13 eV is required for ionizing Xe, and an energy of 8.28 eV or more is required for exciting Xe. In particular, energies of 8.28 eV, 8.45 eV, and 9.57 eV are respectively required to excite Xe to the states of 1S₅, 1S₄ and 1S₂. When the excited Xe (Xe*) is stabilized, ultraviolet rays of about 147 nm are generated. When the Xe* in an excited state collides with the Xe in a ground state, eximer Xe (Xe₂*) is generated. The Xe₂* is stabilized, and thus, ultraviolet rays of about 173 nm are generated.

Accordingly, an E-beam, which is emitted into the cell 114 by the electron accelerating layer 140, may have an energy in the range of 8.28 eV to 12.13 eV in order to excite Xe. In this case, the E-beam may have an energy equal to and/or within the range of 8.28 eV to 9.57 eV or 8.28 eV to 8.45 eV. In addition, the E-beam may have an energy equal to and/or within the range of 8.45 eV to 9.57 eV.

Referring again to FIG. 1, in some embodiments of the invention, such as the exemplary gas excitation light-emitting device 100, the first electrode 131 may be formed on the first substrate 110. In some embodiments, the first, second and third electrodes 131, 132 and 133 may all formed be on the first substrate 110, and the phosphor layer 115 may be formed on the entire or substantially the entire cell-facing-surface portion 120a of the second substrate 120 corresponding to the respective cell 114.

FIG. 3 illustrates a cross-sectional view of a gas excitation light-emitting device 200 according to another exemplary embodiment of the invention. In general, only differences between the exemplary gas excitation light-emitting device 200 of FIG. 3 and the exemplary gas excitation light-emitting device 100 of FIG. 1 will be described below.

The gas excitation light-emitting device 200 of FIG. 3 corresponds to the gas excitation light emitting device 100 of FIG. 1, without the third electrode 133. That is, the gas excitation light emitting device 200 is a two-electrode version of the gas excitation light emitting device 100 of FIG. 1.

Referring to FIG. 3, the gas excitation light-emitting device 200 may include a first substrate 210, a second substrate 220, a barrier rib 213, a cell 214, a first electrode 231, a second electrode 232, an electron accelerating layer 240, and a dielectric material layer 250.

Referring to FIG. 3, in some embodiments, e.g., the exemplary embodiment illustrated in FIG. 3, a stacked combination of corresponding ones of the barrier rib(s) 313, the second electrode 332 and the dielectric material layer 350 may have a height H1 equal to an interval between first and second substrates 310, 320.

The dielectric material layer 250 may be interposed between the first electrode 231 and the second electrode 232, via the first substrate 210, so as to insulate the first electrode 231 from the second electrode 232. The first electrode 231 may correspond to a cathode, and the second electrode 232 may correspond to an anode.

The barrier rib 213 may be formed on the second electrode 232, and the barrier rib 213 may be interposed between the second electrode 232 and the second substrate 220.

As illustrated in FIG. 3, the second electrode 232 may be formed to protrude into the cell(s) 214. In some embodiments, a protruding area of the second electrode 232, along an x-direction, into the respective cell 214, may be increased. Thus, conductivity of the second electrode 232 may be increased, and a thickness of the second electrode 232 along a y-direction may be reduced. Thus, manufacturing costs of the gas excitation light-emitting device 200 of FIG. 3 may be reduced.

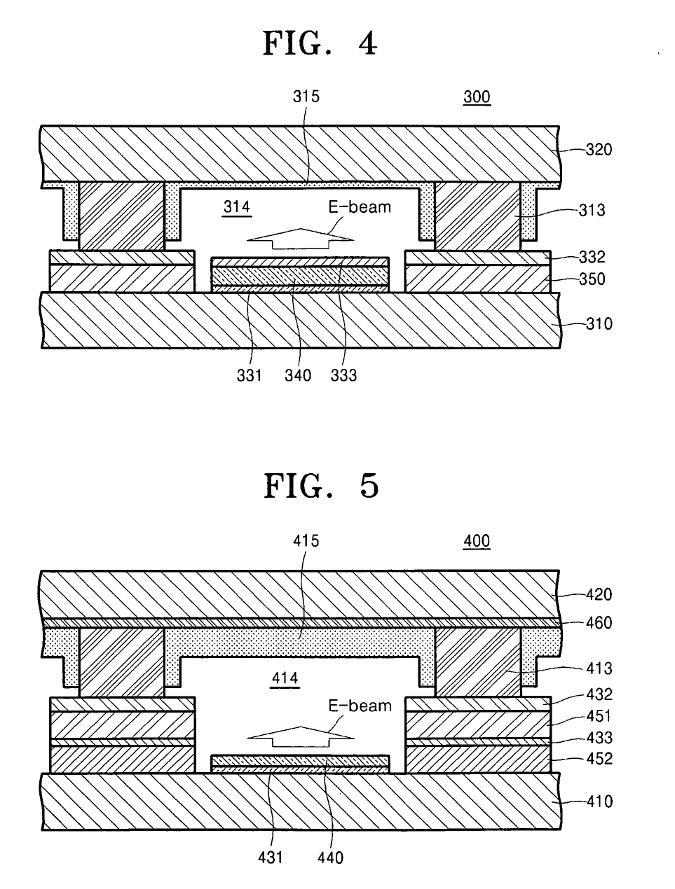

FIG. 4 illustrates a cross-sectional view of a gas excitation light-emitting device 300 according to another embodiment of the invention. In general, only differences between the exemplary gas excitation light-emitting device 300 of FIG. 4 and the exemplary gas excitation light-emitting device 200 of FIG. 3 will be described below.

Referring to FIG. 4, the gas excitation light-emitting device 300 may include a first substrate 310, a second substrate 320, a barrier rib 313, a cell 314, a first electrode 331, a second electrode 332, a third electrode 333, an electron accelerating layer 340, and a dielectric material layer 350.

That is, the exemplary gas excitation light-emitting device 300 of FIG. 4 corresponds to the exemplary gas-excitation light-emitting device 200 of FIG. 3, which further includes the third electrode 333 on the electron accelerating layer 340 thereof. The third electrode 333 may correspond to a grid electrode.

When a predetermined voltage is applied to the first electrode 331 and third electrode 333, the electron accelerating layer 340 may accelerate electrons from the first electrode 331 to emit an E-beam through the third electrode 333 to an inside of the respective cell 314. The excited beam emitted into the respective cell 314 may excite the gas in the cells 314 such that the gas is stabilized to generate ultraviolet rays. In addition, the ultraviolet rays may excite a phosphor layer 315 so as to generate visible rays that are emitted towards the second substrate 320 to form an image.

FIG. 5 illustrates a cross-sectional view of a gas excitation light-emitting device 400 according to another exemplary embodiment of the invention. In general, only differences between the exemplary gas excitation light-emitting device 400 of FIG. 5 and the exemplary gas excitation light-emitting device 100 of FIG. 1 will be described below.

The gas excitation light-emitting device 400 of FIG. 5 corresponds to the gas excitation light emitting device 100 of FIG. 1, and further including a reflective layer 460. More particularly, the gas excitation light-emitting device 400 of FIG. 5 may be a reflective structure.

Referring to FIG. 5, the gas excitation light-emitting device 500 may include a first substrate 410, a second substrate 420, a barrier rib 413, a cell 414, a first electrode 431, a second electrode 432, a third electrode 433, an electron accelerating layer 440, a first dielectric material layer 451, a second dielectric material layer 452, and the reflective layer 460.

The exemplary gas excitation light-emitting device 400 illustrated in FIG. 5 may be a reflective structure, and may be configured so as to display an image(s) through the first substrate 410. Each of exemplary gas excitation light-emitting devices 100, 200, 300 of FIGS. 1, 3 and 4, respectively, were described as backlit structures in which generated visible rays may be emitted through the second substrate 120, 220, 320, respectively, to form an image.

In the exemplary embodiment 400 of FIG. 5, visible rays may be transmitted through the phosphor layer 415 so as to be emitted from the first substrate 410. in general, when a thickness of the phosphor layer 415 is reduced, transmission may be improved. However, because an intensity of radiation of the visible rays generated from the phosphor layer 415 may be reduced, a brightness of the phosphor layer 415 may be reduced. Further, when the thickness of the backlit phosphor layer 415 is increased in order to increase the brightness of the phosphor layer, because electrons that accelerate towards the second electrode 432 may be charged on a surface of the phosphor layer 415, a brightness of the phosphor layer 415 may be reduced. Accordingly, a thickness of the phosphor layer 415 of the exemplary embodiment of the gas excitation light-emitting device 400, configured as a reflective structure in which the generated visible rays may be emitted towards the first substrate 410 to form an image, may be set to have an appropriate thickness in view of, e.g., the above-mentioned tradeoffs.

That is, the phosphor layer 415 may be formed to have an appropriate thickness so that visible rays are not transmitted through the phosphor layer 415, and those that are transmitted may be reflected back by the reflective layer 460 through the phosphor layer 415 so as to be emitted towards the first substrate 410 to form an image(s). In some embodiments, a thickness of the phosphor layer 415 in such a reflective structure may be equal to and/or within a range of about 30 μm to about 60 μm.

In some embodiments, the reflective layer 460 may not be provided. In some embodiments, the reflective layer 460 may be provided between the second substrate 420 and the phosphor layer 415. In such embodiments, a part of the visible rays transmitted through the phosphor layer 415 may be reflected by the reflective layer 460 so that the visible rays may be emitted towards the first substrate 410. The reflective layer 460 may include, e.g., aluminum, silver and/or calcium. The reflective layer 460 may simultaneously function as the second electrode 432, such that the second electrode 432 may not be provided between the barrier rib(s) 413 and the first substrate 410.

In some embodiments of a reflective structure, the reflective structure may include a phosphor layer having a thickness that is greater than a thickness of a phosphor layer employed in a backlit structure. Thus, brightness and an efficiency of such a reflective structure may be improved. Further, the gas excitation light-emitting device 400 may include the reflective layer 460, and thus, luminous efficiency thereof may be further improved.

FIG. 6 illustrates a cross-sectional view of a gas excitation light-emitting device 500 according to another exemplary embodiment of the invention. In general, only differences between the exemplary gas excitation light-emitting device 500 of FIG. 6 and the exemplary gas excitation light-emitting device 100 of FIG. 1 will be described below.

Referring to FIG. 6, the gas excitation light-emitting device 500 may include a first substrate 610, a second substrate 620, a barrier rib 613, cells 614a, 614b, 614c, a first electrode 631, second electrodes 632a, 632b, 632c, third electrodes 633a, 633b, 633c, an electron accelerating layer 640, a first dielectric material layer 651, a second dielectric material layer 652, and a second barrier rib 616.

The gas excitation light-emitting device 500 of FIG. 6 corresponds to the gas excitation light emitting device 100 of FIG. 1, and further including the second barrier rib(s) 616 such that adjacent ones of the cells 614a, 614b, 614c each have separate corresponding portions of the second and third electrodes 632a and 633a, 632b and 633b, and 632c and 633c, respectively.

More particularly, in the exemplary gas excitation light-emitting device 100 of FIG. 1, the second electrode 132 and the third electrode 133 may affect a state of adjacent ones of the cells 114. In the exemplary embodiment 500 illustrated in FIG. 6, the second barrier ribs 616 may be provided so as to separate respective portions of the second and/or third electrodes 632, 633. In the exemplary embodiment 500, e.g., the cell 614a may correspond to multiple portions of the respective second and third electrodes 632a, 633a on opposing sides of the cell 614a.

More particularly, in the gas excitation light-emitting device 500 of FIG. 6, each of adjacent ones of the cells, e.g., 614a, 614b, may be associated with a respective one of electrically isolated portions 632a, 632b of the second electrode 632 extending between the cells 614a, 614b, a respective one of electrically isolated portions 633a, 633b of the respective third electrode 633 extending between the cells 614a, 614b, a respective one of portions 651a, 651b of the first dielectric material layer 651 extending between the cells 614a, 614b, and a respective one of portions 652a, 652b of the second dielectric material layer 652 extending between the cells 614a, 614b, respectively, by way of the second barrier rib(s) 616.

Similarly, in the gas excitation light-emitting device 500 of FIG. 6, each of adjacent ones of the cells, e.g., 614a, 614c, may be associated with a respective one of electrically isolated portions 632a, 632c of the second electrode 632 extending between the cells 614a, 614c, a respective one of electrically isolated portions 633a, 633c of the respective third electrode 633 extending between the cells 614a, 614c, a respective one of portions 651a, 651c of the first dielectric material layer 651 extending between the cells 614a, 614c, and a respective one of portions 652a, 652c of the second dielectric material layer 652 extending between the cells 614a, 614c, respectively, by way of the second barrier rib(s) 616.

Accordingly, in some embodiments of the invention, when, e.g., a first voltage is applied to the second electrode 632a of the cell 614a, a separate voltage (same or different from the first voltage) may be applied to the second electrode 632b of the cell 614b and another separate voltage (same or different from the first voltage) may be applied to the second electrode 632c of the cell 614c. Similarly, in some embodiments of the invention, when, e.g., a first voltage is applied to the third electrode 633a of the cell 614a, a separate voltage (same or different from the first voltage) may be applied to the third electrode 633b of the cell 614b and another separate voltage (same or different from the first voltage) may be applied to the second electrode 633c of the cell 614c.

Although the gas excitation light-emitting device 500 is illustrated as a three electrode structure, including the first electrodes 631a, 631b, 631c, the second electrodes 632a, 632b, 632c and the third electrodes 633a, 633b, 633c, embodiments of the invention are not limited thereto. That is, the gas excitation light-emitting device 500 may be used, e.g., as a two electrode structure. Also, similar to the three electrode structure illustrated in FIG. 4, the third electrode 633 may be formed on the first electrode 631. That is, the second barrier rib(s) 616 is not limited to the exemplary embodiment illustrated in FIG. 6, and may be employed in various embodiments of the invention. Further, the gas excitation light-emitting device 500 of FIG. 6 may be configured as a reflective structure in addition to a backlit structure as illustrated in FIG. 6.

FIG. 7 illustrates a cross-sectional view of a gas excitation light-emitting device 600 according to another exemplary embodiment of the invention.

In the gas excitation light-emitting device 600 of FIG. 7, an electrode(s) may be arranged perpendicular and/or substantially perpendicular to first and second substrates 510, 520.

Referring to FIG. 7, the exemplary gas excitation light-emitting device 600 may include the first substrate 510, the second substrate 520, a plurality of cells 514, a plurality of address electrodes 511, a first electrode 531, a second electrode 532, a third electrode 533, a fourth electrode 534, a first electron accelerating layer 541, a second electron accelerating layer 542, a dielectric material layer 512, phosphor layer(s) 515 of red R, green G and blue B. The first and second substrates 510, 520 may be disposed facing each other by a predetermined interval. The plurality of cells 514 may be defined between the first substrate 510 and the second substrate 520. The address electrodes 511 may be formed on the first substrate 510. The address electrodes 511 may be covered with the dielectric material layer 512. The phosphor layers 515 of red R, green G and blue B may be respectively formed on inner walls of the cells 514. The cells 514 may be filled with an excitation gas including, e.g., Xe.

The first electrode 531 and the second electrode 532 may be formed between the first substrate 510 and the second substrate 520 in respective cells 514. The first and second electrodes 531 and 532 may be respectively formed on opposing sides of each of the cells 514. The first and second electron accelerating layers 541 and 542 may be respectively formed on inner surfaces of the first and second electrodes 531 and 532. The third and fourth electrodes 533 and 534 may be respectively formed on the first and second electron accelerating layers 541 and 542. The first and second electron accelerating layers 541, 542 may be formed of any material that accelerates electrons so as to generate an E-beam, e.g., OPS.

The first electron accelerating layer 541 may emit a first E-beam (E₁-beam) into the respective cell(s) 514 when a predetermined voltage is applied to each of corresponding ones of the first electrode 531 and the third electrode 533. The second electron accelerating layer 542 may emit a second E-beam (E₂-beam) into the cells 514 when a predetermined voltage is applied to each of the second electrode 532 and the fourth electrode 534. The E₁-beam and the E₂-beam are alternately emitted into the cells 514 when an alternating current voltage is applied between the first electrode 531 and the second electrode 532. Each of the E₁-beam and the E₂-beam excites an excitation gas that is stabilized to generate ultraviolet rays exciting the phosphor layer 515. Accordingly, each of the E₁-beam and the E₂-beam may have an energy that is greater than the energy required for exciting the excitation gas and less than an energy required for ionizing the excitation gas. In particular, each of the E₁-beam and the E₂-beam may have an energy equal to and/or within a range of about 8.28 eV to about 12.13 eV, which may be employed to excite Xe.

The third and fourth electrodes 533 and 534 may be formed in a mesh structure so that electrons accelerated by the first and second electron accelerating layers 541 and 542 may be easily emitted into the cells 514. The first and second electron accelerating layers 541 and 542 may be formed so as to at least partially define a cell space, which is defined between the first substrate 510 and the second substrate 520, and corresponds to respective ones the cells 514. However, embodiments are not limited thereto. For example, in some embodiments, a plurality of barrier ribs (not shown) may be further formed between the first substrate 510 and the second substrate 520 so as to define a cell space, which is defined between the first substrate 510 and the second substrate 520 corresponding to each of the cells 514.

In the gas excitation light-emitting device 600 of FIG. 7, a voltage having a pulse waveform may be applied to each of the first electrode 531, the second electrode 532, the third electrode 533 and the fourth electrode 534, where each of voltages may be respectively denoted by V₁, V₂, V₃ and V₄, and may satisfy the conditions such that V₁<V₃ and V₂<V₄. When the voltages V₁, V₂, V₃ and V₄ are respectively applied to the electrodes, the E₁-beam may be emitted into the cells 514 by the first electron accelerating layer 541 due to the voltages V₁, V₃ that are applied to the first and third electrodes 531 and 533. In addition, the E₂-beam may be emitted into the cells 514 by the second electron accelerating layer 542 due to the voltages V₂, V₄ that are applied to the second and fourth electrodes 532 and 534. Since an alternating current voltage may be applied to the first electrode 531 and the second electrode 532, the E₁-beam and the E₂-beam may be alternately emitted into the cells 514 to excite the excitation gas.

As described above, in a conventional plasma display panel and flat lamp in which plasma discharge is used, a relatively large amount of energy is necessary to ionize a discharge gas. Embodiments of the invention may enable an image to be formed using only an energy of electrons emitted when an electron accelerating layer is excited.

Embodiments of the invention may separately further reduce a driving voltage of such gas excitation light-emitting devices.

Embodiments of the invention may separately further improve luminous efficiency of such gas excitation light-emitting devices as compared to conventional devices, e.g., conventional plasma display panel(s) and/or conventional flat panel(s) in which plasma discharge is employed.

Embodiments of the invention may separately enable an exposed area of an electrode in a cell of such gas excitation light-emitting devices to be reduced.

Embodiments of the invention may separately enable an area of a phosphor layer coated in a cell of such gas excitation light-emitting devices to be increased.

Embodiments of the invention may separately enable a brightness of a phosphor layer of such gas excitation light-emitting devices to be improved.

Embodiments of the invention may separately provide such gas excitation light-emitting devices including any one or more of the above and/or other features and/or advantages of the invention in a reflective-type or backlit-types gas excitation light-emitting device, e.g., a flat lamp, PDP, etc.

Exemplary embodiments of the invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A gas excitation light-emitting device, comprising:
a first substrate and a second substrate that are disposed facing each other by a predetermined interval, wherein a plurality of cells are defined between the first substrate and the second substrate;
an excitation gas in each of the cells;
a phosphor layer in each of the cells;
a plurality of electrodes disposed between the first substrate and the second substrate; and
an electron accelerating layer emitting an E-beam in each of the cells, wherein, for each of the cells,
the electron accelerating layer excites the excitation gas in the cell when a voltage is applied to corresponding ones of the electrodes of the cell,
the phosphor layer is spaced apart from the electrodes of the cell, and
the phosphor layer is arranged in a first portion of the cell other than a second portion of the cell between corresponding ones of the electrodes of the cell.

2. The gas excitation light-emitting device as claimed in claim 1, wherein the phosphor layer is formed on an entire cell-facing surface portion of at least one of the first substrate and the second substrate of the respective cell.

3. The gas excitation light-emitting device as claimed in claim 1, wherein the electron accelerating layer includes oxidized porous silicon.

4. The gas excitation light-emitting device as claimed in claim 1, further including a first barrier rib partially extending between adjacent ones of the cells and protruding from the second substrate, wherein a portion of the respective phosphor layer also covers a portion of the barrier rib.

5. The gas excitation light-emitting device as claimed in claim 4, wherein a portion of the phosphor layer on the barrier rib is thicker than a portion of the phosphor layer on the second substrate.

6. The gas excitation light-emitting device as claimed in claim 4, wherein, for each of the cells, the electrodes include a first electrode and a second electrode,
the first electrode being arranged on the first substrate with the electron accelerating layer stacked thereon, and
the second electrode arranged between adjacent ones of the cells and stacked with the first barrier rib between the first substrate and the second substrate.

7. The gas excitation light-emitting device as claimed in claim 6, wherein the second electrode protrudes into the cell relative to the first barrier rib.

8. The gas excitation light-emitting device as claimed in claim 6, further comprising a first dielectric material layer between the first substrate and the second electrode.

9. The gas excitation light-emitting device as claimed in claim 8, further comprising a third electrode between the first barrier rib and the first substrate.

10. The gas excitation light-emitting device as claimed in claim 9, further comprising a second dielectric material layer between the second electrode and the third electrode.

11. The gas excitation light-emitting device as claimed in claim 6, further comprising a reflective layer formed between the second substrate and the phosphor layer.

12. The gas excitation light-emitting device as claimed in claim 1, wherein at least one of the electrodes is arranged between adjacent ones of the cells, and the device further comprises a second barrier rib between respective portions of the at least one of the electrodes between adjacent ones of the cells.

13. The gas excitation light-emitting device as claimed in claim 12, wherein at least one dielectric material layer is also arranged between adjacent ones of the cells and between the at least one electrode and the first substrate, and the second barrier rib extends between respective portions of the at least one dielectric material layer.

14. The gas excitation light-emitting device as claimed in claim 13, further comprising a first barrier rib arranged on the at least one electrode, wherein:
the first barrier rib, the at least one second electrode and the at least one dielectric material layer are stacked on each other between the first and second substrates, and
the second barrier rib protrudes from the first substrate and extends between the respective portions of the at least one electrode and the respective portions of the at least one dielectric material layer.

15. The gas excitation light-emitting device as claimed in claim 1, wherein, for each of the cells, the respective phosphor layer is arranged on one of an upper portion and a lower portion of the cell, and respective corresponding portions of the electrodes are arranged on the other of the upper portion and the lower portion of the cell.

16. The gas excitation light-emitting device as claimed in claim 1, wherein an image is displayed through the second substrate.

17. The gas excitation light-emitting device as claimed in claim 1, wherein an image is displayed through the first substrate.

18. The gas excitation light-emitting device as claimed in claim 1, wherein the device is one of a plasma display panel and a flat lamp.

19. The gas excitation light-emitting device as claimed in claim 1, wherein the first portion is one of an upper portion and a lower portion of the cell, and the second portion is the other of the upper portion and the lower portion of the cell.

20. A gas excitation light-emitting device, comprising:
a first substrate and a second substrate that are disposed facing each other by a predetermined interval, wherein a plurality of cells are defined between the first substrate and the second substrate;
an excitation gas filled into the cells;
a phosphor layer disposed in each of the cells;
a plurality of electrodes disposed between the first substrate and the second substrate; and
an electron accelerating layer emitting an E-beam that excites the excitation gas in the cells,
wherein:
the electrodes are disposed on one of the first substrate and the second substrate,
the phosphor layer is disposed on the other one of the first substrate and the second substrate, and
the phosphor layer is spaced apart from the electrodes.

21. A gas excitation light-emitting device comprising:
a first substrate and a second substrate which are disposed facing each other by a predetermined interval, wherein a plurality of cells are formed between the first substrate and the second substrate;
an excitation gas filled into the cells;
a phosphor layer formed on an inner wall of the cells;
a first electrode and a second electrode formed on the substrate as a pair that define a discharge space that is defined between the first substrate and the second substrate, so as to form the cells;
a third electrode formed inside the first electrode; and
a first electron accelerating layer formed between the first substrate and the third substrate, and which emits a first E-beam that excites the excitation gas in the cells when a voltage is applied to the first electrode and the third electrode.

22. The device of claim 21, wherein the phosphor layer is formed on the entire surface of one of the first substrate and the second substrate.

23. The device of claim 21, further comprising:
a fourth electrode formed inside the second electrode; and
a second electron accelerating layer formed between the second electrode and the fourth electrode, and which emits a second E-beam that excites the excitation gas in the cell when a voltage is applied to the second electrode and the fourth electrode.

24. The device of claim 23, wherein the first electron accelerating layer and the second electron accelerating layer include oxidized porous silicon.

25. The device of claim 23, wherein each of the third electrode and the fourth electrode has a mesh structure.
